(19) United States
(12) Patent Application Publication
(10) Pub. No.: US 2010/0187168 A1
(43) Pub. Date: Jul. 29, 2010

(54) PERCOLATING FILTER SYSTEM WITH A REMOVABLE CARTRIDGE

(76) Inventor: Maurizio Moretto, Vicenza (IT)

Correspondence Address: CASTELLANO PLLC, P.O. Box 1555, Great Falls, VA, 22066, US

(21) Appl. No.: 12/668,770

(22) PCT Filed: May 19, 2008
(86) PCT No.: PCT/EP2008/003991

§ 371 Date: Jan. 22, 2010

(30) Foreign Application Priority Data
Jul. 20, 2007 (IT) PD2007A00249

(51) Int. Cl. B01D 35/143; B01D 27/00

(52) U.S. Cl. 210/86

(57) ABSTRACT

A percolating filter system (1) comprises:
a first (7) and a second (8) reservoir, for collecting the water to be filtered and for collecting the filtered water respectively;
a passage (9) between the first and the second reservoir (7, 8),
a replaceable filter cartridge (12) removably inserted into the passage (9),
sensor means (14a-c) for detecting the water level in at least one of the reservoirs (7, 8), comprising at least one capacitive field-effect sensor positioned in at least one of the reservoirs (7, 8) at a predetermined filling level
calculating means (13) connected to the sensor means (14a-c) in order to calculate the total quantity of water introduced into at least one of the reservoirs (7, 8) in successive fillings of the reservoirs (7, 8), and consequently to determine the state of efficiency of the cartridge (12) in order to indicate its exhaustion.

### TECHNICAL FIELD

The invention relates to a percolating filter system with a removable cartridge having the characteristics mentioned in the preamble of the principal claim.

These filter systems are commonly used for treating water for domestic and food use, for the construction of jugs, cafetieres, teapots and electric kettles.

### TECHNOLOGICAL BACKGROUND

Jugs having these characteristics are known, for example, from EP 1 484 097.

The jugs described in this patent make use of the conductive properties of tap water to close the normally open circuit between two electrical contacts which are submerged in the water to be treated when the water is introduced into the upper or lower reservoir of the jug.

However, this technology has a number of drawbacks, arising on the one hand from the complexity of construction and the instability of the electrode system over time, and on the other hand from the fact that the system is liable to give false readings and in any case has significant electricity consumption.

### DESCRIPTION OF THE INVENTION

The technical problem which the present invention is intended to resolve is that of providing a filter system specifically designed for the construction of jugs, kettles and the like which is structurally and functionally designed to overcome all the drawbacks of the aforementioned known art.

This problem is resolved by the invention by means of a filter system having the characteristics described in the appended claims.

### BRIEF DESCRIPTION OF THE DRAWINGS

The features and advantages of the invention will become clear from the following detailed description of a preferred, but not exclusive, example of embodiment of the invention, illustrated, for the purposes of guidance and without restrictive intent, with reference to the appended drawings, in which:

FIG. 1 is a schematic sectional view;

FIGS. 2 to 4 are sectional views, corresponding to that of FIG. 1, of three variant embodiments of the invention.

### PREFERRED EMBODIMENTS OF THE INVENTION

In the drawings, the number 1 indicates the whole of a filter system including a jug 2 for filtering drinking water.

The jug 2 is provided with a handle 3 and a removable lid 4, and contains a hopper 6 which divides the jug into a first and a second reservoir 7, 8 intended, respectively, to contain the water to be filtered and to contain the filtered water.

In a base wall 7a of the first reservoir a passage 9 opens, forming a seat 10 in which a perimetric edge 11 of a replaceable filter cartridge 12 is received in a watertight way.

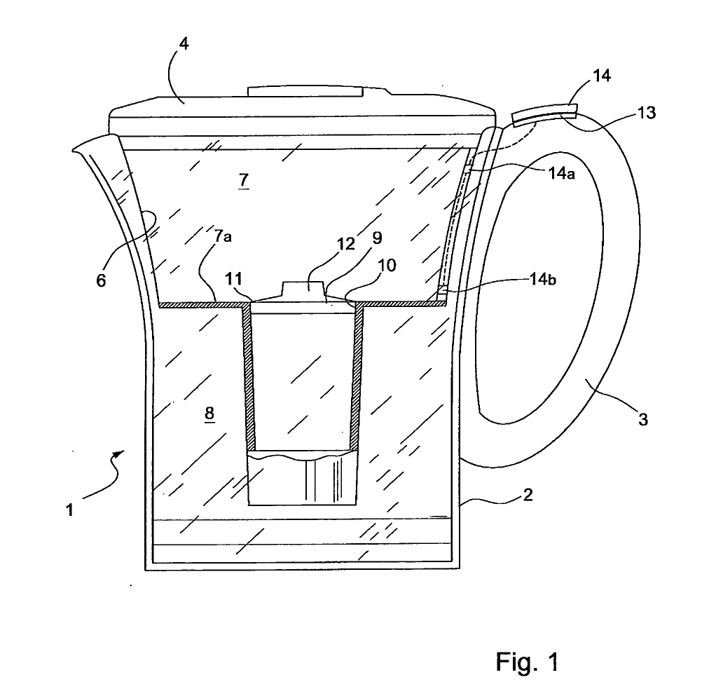

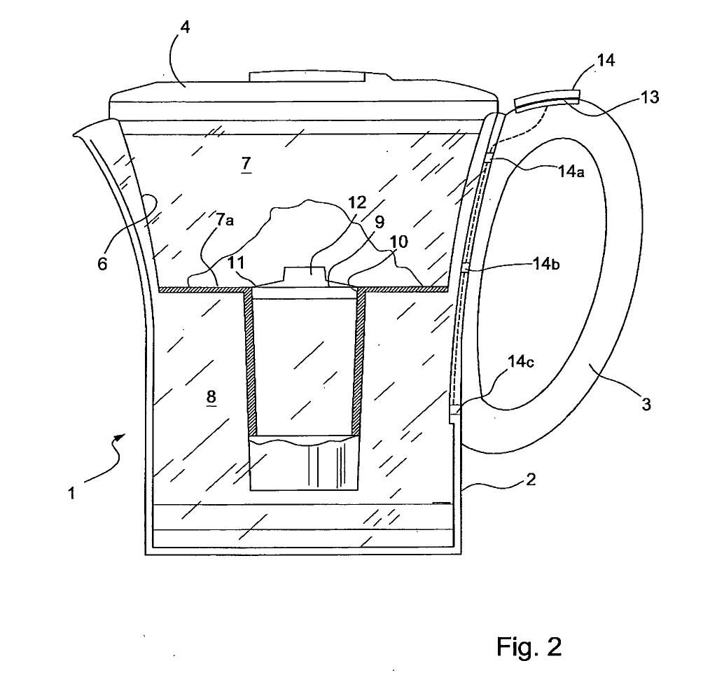

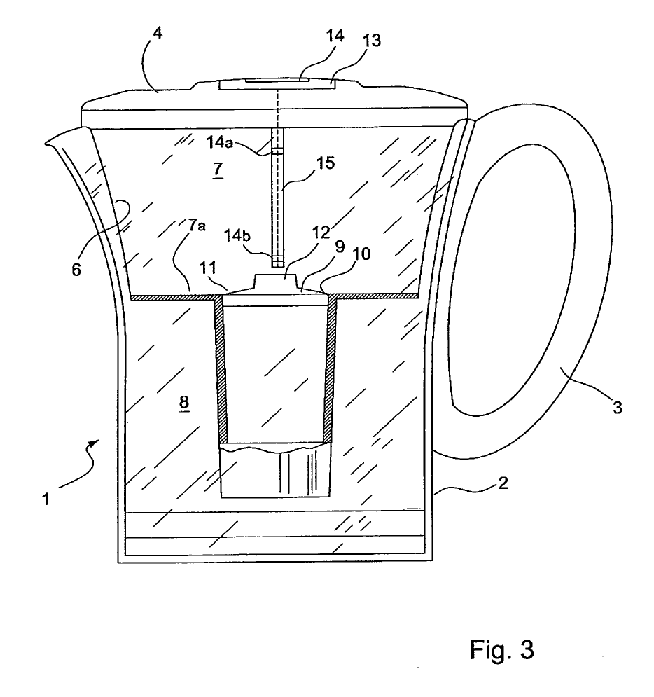

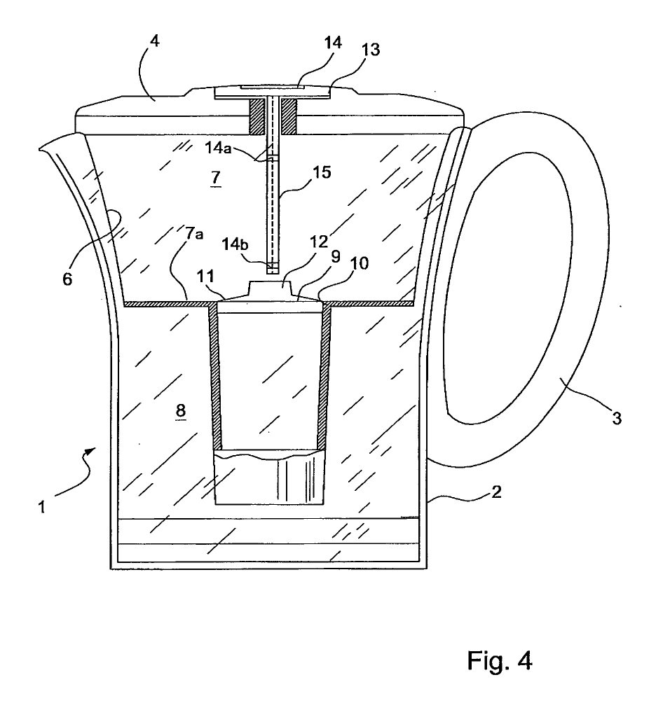

The cartridge 12 has to be replaced at the end of its efficient working life, which is determined as a function of the total volume of water filtered, the time elapsed since its first activation, and/or other factors which are taken into account by a calculation device 13 located, for example, in the handle of the jug 2, or on the lid 4. The calculation device 13 comprises a display 14 for indicating the exhaustion of the cartridge, in order to suggest its replacement when the efficiency of the cartridge has reached a threshold such that adequate filtering performance can no longer be guaranteed. The calculation device 13 is also connected to one or more sensors 14a-n which in FIG. 1 are located on the outer wall of the hopper. The sensor 14a is located at a maximum filling level of the first reservoir (and will be referred to as the “distal sensor” with respect to the base of the reservoir), while the sensor 14b is located at the base (and will be referred to as the “proximal sensor”). In FIG. 2, three sensors 14a-c are used, all located on the outer wall of the jug 2. In FIG. 3, the sensors 14a, b form part of a rod-like element 15 which projects into the jug, in the first reservoir 7, from the lid 4. In FIG. 4, the sensors 14a-c form part of a rod-like element 15 which is fixed to the calculation device 13 and to the display 14 and is removably associated with the lid 4, the rod-like element 15 passing through a hole 16 in the lid 4. In both of the two cases shown in FIGS. 3 and 4, the sensors are embedded in the plastics material which forms the rod-like element, while in the cases of FIGS. 1 and 2 they are applied to the outside of the corresponding reservoir in such a way that they never come into direct contact with the water. Additionally, in the examples of FIGS. 3 and 4, the sensors and the corresponding rod-like element are preferably separated from the walls of the jug, in order to avoid disturbance of their operation, for example when a hand is brought towards the jug or when the jug is brought towards another object. A preferred positioning for this purpose is along a vertical rod-like element which is centred with respect to the lateral walls of the jug.

In all the illustrated cases, the sensors 14a-n are of the capacitive field-effect type, such as the sensors marketed by Touchsensor Technologies LLC of Wheaton (Ill.), USA. These sensors can detect the presence of a body, such as the body of water contained in the reservoirs 7, 8, as its level rises, without requiring any direct contact with the liquid. When the presence of water is detected by the proximal sensor at the base of the corresponding reservoir, the distal sensor is activated for detection, and this sensor in turn indicates the complete filling of the reservoir. The signal sent by the distal sensor to the calculation device is used to calculate the quantity of water introduced into the reservoir in successive fillings of the reservoir, and consequently to determine the efficiency of the cartridge for the purpose of indicating its exhaustion. Preferably, the proximal sensor at the base of the reservoir enables the reading of the signal relayed by the distal sensor for a limited period, in such a way that, if no signal is read at the distal sensor within a conveniently limited period (for example 30 seconds) from the activation of the proximal sensor, the distal sensor is temporarily disabled until the next enabling of the proximal sensor. This serves to limit the possibility of false readings of the sensors.

The invention thus resolves the stated problem while also providing numerous benefits such as low electricity consumption for the operation of the device, particularly small overall dimensions, and accurate operation, partially due to the fact that the sensors are not brought into contact with the water. Furthermore, the filter system according to the invention is suitable for the construction not only of jugs but also of electric kettles, cafetieres and similar devices, and can also be used to indicate both the exhausted condition of a cartridge and also the need to carry out various kinds of maintenance operations on the machine.

1. A percolating filter system comprising:
a first and a second reservoir, for collecting water to be filtered and for collecting the filtered water respectively;
a passage between said reservoirs,
a replaceable filter cartridge removably inserted into said passage,
sensor means for detecting the level of water in at least one of said reservoirs,
calculating means connected to said sensor means in order to calculate the total quantity of water introduced into said at least one of said reservoirs in successive fillings of the reservoirs, and consequently to determine the state of efficiency of the cartridge in order to indicate its exhaustion,
wherein said sensor means comprise at least one capacitive field-effect sensor positioned in at least one of said reservoirs at a predetermined filling level.

2. The filter system according to claim 1, wherein said at least one of said reservoirs is the first reservoir for collecting the water to be filtered.

3. The filter system according to claim 1, wherein said sensor means comprise a plurality of capacitive field-effect sensors positioned in at least one of said reservoirs at predetermined filling levels including a proximal level and the distal level with respect to the base of said reservoir.

4. The filter system according to claim 1, wherein said sensors means in said at least one reservoir are separated from the walls of the reservoir.

5. The filter system according to claim 2, wherein said sensor means are supported on a rod-like element removably associated with a lid of said first reservoir containing water to be filtered.

6. The filter system according to claim 1, wherein said filter system comprises a jug or kettle using a replaceable cartridge.
